(19) United States
(12) Patent Application Publication
(10) Pub. No.: US 2015/0060145 A1
(43) Pub. Date: Mar. 5, 2015

(54) Drilling Fluid That Fracks While Drilling And Can Be Used In Well Completion

(71) Applicant: Daryl Breese, Brooklyn, CT (US)

(72) Inventor: Daryl Breese, Brooklyn, CT (US)

(21) Appl. No.: 14/016,113

(22) Filed: Sep. 1, 2013

(51) Int. Cl. C09K 8/04; E21B 7/00

(52) U.S. Cl. CPC C09K 8/04; E21B 7/00
USPC 175/65

(57) ABSTRACT

A method of fracturing a subterranean formation while drilling, applying a new combination of completion techniques. When combined to work simultaneously together, these techniques have synergistic amplified benefits, dynamically opening fissures deep into the production zone. The saturated saltwater phase of the drilling fluid dehydrates all the clays and shale that are drilled through, by osmosis-opening up or enlarging production channels or paths while the relaxed filtrate penetrates further into the wall of the well bore through the naturally occurring fissures or channels in the formation. The saturated salt water fluid with a relaxed filtrate combines with a (0.5-5% by volume) variety of acids (encapsulated by natural oils or polymers) to acid etch or scour the clay or shale walls leaving an acid etch matrix of channeling for later hydrocarbon production.

### FIELD OF THE INVENTION

The present invention relates to oil and gas wells and more particularly to a method and apparatus of applying a specialized drilling fluid to the drilling process of the oil and gas wells.

### BACKGROUND

Oil and gas wells have been drilled for well over a century. There are ongoing new methods developed that work better—improving production; safety; time savings and address environmental concerns. Because of surface spills and water aquifer contamination from hydrofracking, it is being banned in more and more places—France in 2011; Vermont; New York State; and Pomfret, Conn. California; Ohio; West Virginia and Pennsylvania may ban fracking soon.

When a pad is cleared and leveled for drilling and production, the directional wells on the lease have been plotted out and can extend a mile or two in any direction. A 6-8′ deep cellar hole is dug about ten feet wide by backhoe, and a smaller rotary drilling rig or air drilling rig with large air compressors, can MIRU (move in rig up), and drill the vertical surface holes. Depending on the known strata below, and over 99% of wells drilled are in known producing fields, the first surface hole is drilled with a large, for example 26″ diameter bit designed for drilling through rock down to 200′ with an inexpensive thick gel (bentonitic clay) of 5-10 PPB (pounds per barrel) and/or polymer (drispac or similar) of 1-2 PPB for a high viscosity (60-100 seconds/quart as measured with a API Marsh Funnel) mud to carry the cuttings out of the hole; and then 20″ diameter casing is run down to 200′ and cemented into place. Some areas, like the Western Pennsylvania, Marcellus Shale, drillers may hit caverns left from old coal mines, and may result in simply drilling “blind” without any fluid returns to surface while the drilled cuttings come up the hole and fill into the cavern. Under these circumstances, air drilling is generally preferred. Air drilling utilizes a few chemicals that foam in combination with extremely high air volume and pressure to carry the cuttings out of the hole traveling up the annulus. Drilling “mud” (fluids) are pumped down the smaller diameter hollow drill pipe and come back up the annulus which is the gap between the wall of the vertical well bore and the outside of the drill pipe. The mud pumps are connected to the top of the drill “string” above the rotary table that spins the drill pipe by a swivel and flexible high pressure 4-6″ thick Kelly Hose. With this 20″ surface pipe in place, the crews switch to a smaller bit, average of 12¼″ and with the same fresh water mud, they drill down to the next engineer planned casing point, determined by a variety of conditions. Those conditions may include a need to case off and protect an aquifer or sand zone (which is about 5,000′ or so deep in Galveston Beach, Tex.). The casing depth can vary based on the geography of each field. The number of casing “strings” that are cemented into place can vary from 2-5, as in the case of Range Resources—Canonsburg, Pa. The drilling fluid, if used on these vertical drilling sections is usually a low cost, fresh water polymer that best protects water tables and aquifers. These rigs drill 24/7 with rotating crews.

When the vertical drilling comes to its planned end based on the findings usually reflected by seismic soundings, there is a planned kick off point where a directional drilling motor and bit designed for at least 150 hours of drilling are installed at the bottom of the Bottom Hole Assembly (BHA). After drilling through the cement and “shoe” of the last casing, the directional driller starts to steer this expensive ($100-250K) mud motor to building a curve in the direction of the planned wellbore. Traditionally, the drill string does NOT rotate, instead the pipe stays stationary and the pump pressure turns the bottom of the mud motor and bit. That's called, “sliding”.

A new “point-the-bit” steerable system with 100% drill string rotation improves horizontal hole cleaning better than “bent subs and motors”. This “corkscrewing” motion of the fluid in the annulus, returning to the surface yields a somewhat “turbulent” flow which prevents settling of solids in the lower side of the well bore—yielding a more gauge hole; consistent diameter and represents a better chance for successful completion and maximized production, using any completion method. This new fluid works well in conjunction with this newer steerable system.

### SUMMARY

A drilling fluid method that opens fractures and completes a well includes the steps of:

applying a salt saturated or near salt saturated drilling fluid with water phase to dehydrate shale formations through osmosis;
enlarging a crevice or fracture in hydrocarbon producing formations; and
applying Hydrochloric (or other) Acid to etch matrix shale,
enlarging a crevice or fracture in hydrocarbon producing formations,
applying “gravel packing” of proppants into the producing zone with a saturated salt fluid with an acid resistant polymer to hold open the newly enlarged fracture which would swell and begin to narrow when exposed to the less than saturated salt fluid flow of ground water during production of hydrocarbons.

A Water Based Mud method for drilling horizontal and vertical wells includes the steps of:

applying an acid resistant polymer including a near saturated sodium chloride salt (above 250000 ppm NaCl, 71 ppb) including HCl in the range of 0.5%-5.0%; a biodegradable surfactant; a guar gum; a biocide; a polyacrylamide; a friction reducer; an emulsifier; and a diesel based VOC and BTEX.

A Water Based Mud method for drilling horizontal and vertical wells includes the steps of:

applying an acid resistant polymer including near saturated Potassium Chloride Salt (above 200000 ppm KCl, 79 ppb) with HCl in the range of 0.5%-5.0%; a biodegradable surfactant; a guar gum; a biocide; a friction reducer; a polyacrylamide; an emulsifier; and a diesel based VOC and BTEX.

A Water Based Mud method for drilling horizontal and vertical wells with an acid resistant polymer includes the steps of:

applying near saturated Calcium Chloride Salt (at least 125 ppb CaCl2) with HCl in the range of 0.5%-5.0%; a biodegradable surfactant; a guar gum; a biocide; a polyacrylamide; a friction reducer; emulsifiers; and a diesel based VOC and BTEX.

A Water Based Mud method for drilling horizontal and vertical wells with an acid resistant polymer; includes the steps of:

applying near saturated Sodium Bromide Salt having a concentration of at least 130 ppb NaB with HCl in the range of 0.5%-5.0%; a biodegradable surfactant; a guar gum; a biocide; a polyacrylamide; a friction reducer; an emulsifier; and a diesel based VOC and BTEX.

An Oil Base Mud method with a water phase for drilling horizontal and vertical wells with an acid resistant polymer includes the steps of: applying near saturated sodium chloride salt having a concentration of exceeding 250000 ppm NaCl) with HCl in the range of 0.5%-5.0%; a biodegradable surfactant; a guar gum; a biocide; a polyacrylamide; a friction reducer; an emulsifier; and a diesel based VOC and BTEX.

An Oil Base Mud method with a water phase for drilling horizontal and vertical wells with an acid resistant polymer includes the steps of: applying near saturated Potassium Chloride Salt having a concentration above 200000 ppm KCl with HCl in the range of 0.5%-5.0%; a biodegradable surfactant; a guar gum; a biocide; a polyacrylamide; a friction reducer; an emulsifier; and a diesel based VOC and BTEX.

An Oil Base Mud method with a water phase for drilling horizontal and vertical wells with an acid resistant polymer, includes the steps of: applying near saturated Calcium Chloride Salt having a concentration of at least 125 ppb CaCl2 with HCl in the range of 0.5%-5.0%; a biodegradable surfactant; a guar gum; a biocide; a polyacrylamide; a friction reducer; an emulsifier; and a diesel based VOC and BTEX.

An Oil Based Mud method with a water phase for drilling horizontal and vertical wells with an acid resistant polymer, includes the steps of: applying Sodium Bromide Salt having a concentration of approximately 130 ppb NaBr with HCl in the range of 0.5%-5.0%; a biodegradable surfactant; a guar gum; a biocide; a polyacrylamide; a friction reducer; an emulsifier; and a diesel based VOC and BTEX.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an oil well of the present invention;

FIG. 2 illustrates a production valve of the present invention;

FIGS. 3-5 illustrates data of the present invention.

### DETAILED DESCRIPTION

The present invention includes a method of fracturing a subterranean formation while drilling, applying a combination of completion techniques or methods. When combined to work simultaneously together, these completion techniques have synergistic amplified benefits, dynamically opening fissures deep into the production zone. The saturated saltwater phase of the drilling fluid dehydrates most, if not all the clays and shale that are drilled through, by osmosis-opening up or enlarging crevices, production channels or paths, which average 0.5-1.0 mm, while the relaxed filtrate penetrates further into the wall of the well bore through the naturally occurring fissures or channels in the formation. The saturated salt water fluid with a relaxed filtrate combines with a (approximately 0.5-5% by volume) a variety of acids (which may be encapsulated by natural oils or polymers) to acid etch or scour the clay or shale walls, leaving an acid etch matrix of channeling for later hydrocarbon production. The effective penetration and “acid soak” during days of drilling the horizontal wellbore pay zone is protracted and prolonged. This drilling fluid combination near maximizes fractures and is pressure balanced with the adjacent formation pressure, keeping the drilling fluid localized to the pay zone. The average pressure of 3-4000 PSI of circulating pump pressure along with the density of the “mud” stays at or near the hydrostatic pressure exerted by the formation pressures; unlike the 10-15,000 PSI that hydro-fracturing averages. This drilling fluid may require two to three times the average solids control equipment which keeps the fluid cleaner, so as to run production casing and complete the well with gravel “proppant” sand packing. These artificial or natural preselected sand size particles are packed into place to hold open the fissures that were made from drilling and/or small explosions, as production water with less salt content will flow past these dehydrated clays or shale which may rehydrate and may swell-close the channel. This method of the present invention near maximizes channeling for production and can be used in place of hydro-fracking, especially where packing is banned, saving upwards of four million gallons of water per well; excessive costs; accidents; potential spills and possible aquifer contamination. Tier “1” generally artificial proppants are superior and studies show they pay for their additional costs with increased production by holding crevices stable longer.

This new method maximizes production channeling localized to the pay zone and may replace fracking altogether.

After drilling through the cement and “shoe” of the last casing, the directional driller starts to steer this expensive ($100-250K) mud motor to building a curve in the direction of the planned wellbore. At this point, or just before, the drilling fluid method of the present invention (be it oil or water based) should be employed. The pits are cleaned, and the pits are filled with saturated salt solution and polymer or oil base mud and saturated salt water phase. No weight material is needed; the weight material comes from the salt in solution. As it takes 24-72 hours to drill a curve; now the salt saturated water is made up on location with 120 PPB of NaCl for example being added through the hopper from the 2000 pound reusable waterproof fiber woven sacks. NaCl is the most common salt. Three charts of the most commonly used salt brines are referenced below. The less commonly used brines and blends of salts have standard mixing charts with weight ranges noted in pounds per gallon of: NaBr (8.4-12.7); NH4Cl (8.4-8.9); CaBr2 (8.4-15.2); ZnBr2 (8.4-19.2); KBr (8.4-11.6); NAO2CH (9.0-11.1); and KO2CH (8.4-13.1).

Polymers, like PHPA & Guar Gum/Starch, are the main components for viscosity to be added now at about 3-4 minimum ppb total which is not the standard recommended 1-1.5 ppb, so as to impart additional lubricity and encapsulation capability for the cuttings and carrying capacity. As water or oil is added for volume, salt and polymer levels will be monitored by the Mud Engineer and kept near optimized. The mud weight is kept elevated to desired levels by adjusting the salt in solution. The saturated salt allows to drill a basically gauge hole—actually stabilizing the clays and shale by dehydrating them. A relaxed filtrate is employed by adding approximately 50-100 pounds of lime per twelve hour tour/shift, if needed to minimize any carbonate buildup problems. Adding 50-100 pounds/tour of Sodium Bicarbonate softens hard water additions as the drilling fluid system grows in volume as the hole is drilled, and the Sodium Bicarbonate helps drilling through any calcareous limestone, by treating out the Calcium ions, which can interfere with Salt Ions causing flocculation at higher viscosity. As the circulating mud volume grows, the water or an oil/water mix for oil base mud is added with 120 PPB NaCl for each additional barrel of water added. This is adjusted by the Mud Engineer, who has a portable lab kit which can run about 50 different tests, including chlorides, so he or she can keep the mud's water phase at or near saturation—specifically monitoring the fluids temperature to watch for salt crystallization and fallout. Salt crystals act like solids in the fluid, so mixing the fluid just below saturation, and keeping at this point is tantamount.

Aggressive solids control to maintain an ultra-clean fluid may be in service at this time. The solids control can clean the mud on the “first pass” so it does not get pumped down hole again and get pulverized into many smaller pieces by the bit's nozzle velocity and pressure which can be upwards to 800′/second at 4,000 PSI. A mud cleaner and two centrifuges may be used for wells doing this type of drilling; however the system of the present invention may need to double that to keep the fine low gravity solids as low as possible, in contrast to the 4-6% by volume current industry standard. Mud pumps usually circulate drilling fluids at 10-12 barrels per minute. Centrifuges and mud cleaners can only handle 20-25% of that at 2-3 BBLs/min. This mud system of the present invention may require doubling the compliment of solids control to two mud cleaners and four centrifuges to keep fine solids from packing off the fractures this system will open up when drilling into the hydrocarbon zone. If need be, a non-selective flocculating polymer like MF-1 (available in two pound sacks) can be employed at the “possum belly” return to coagulate and remove these undesirable solids over the shaker screens. Solids; dissolved solids and water/oil ratios are determined by a retort test run at least twice daily allowing adjustments in treatments to maintain parameters of salt saturation; solids; oil/water ratios and LGS (low gravity solids) and HGS (high gravity solids).

While building the curve of the well, preparations are made to add the 0.5-5% acid by volume to the drilling fluid before drilling into the unconventional horizontal play. The saturated salt, relaxed invasive filtrate and solids control are in place. Now, the acid is added to complete the drilling fluid that will maximize fractures in the horizontal pay zone. Additional lubricants; biocides; pH control; surfactants; friction reducers; emulsifiers; soaps; plus exotic diesel based BTEX (Benzene; Toluene; Ethylene; Xylene) and VOC (Volatile Organic Compound) can be added in varying degrees if needed for specific parameters of secondary concerns—as determined by the Mud Engineer and his bi-daily testing. The polymers will interact and encapsulate the acid which gets added at or near the bottom of the curve of the well; the lubricity of the polymers will promote delivery into the channels opened up while drilling by the osmosis from the saturated salt and relaxed filtrate. In Oil Base Systems of the present invention the tightness of the emulsion should be run somewhere between API 300-800 millivolts (as measured by the electrical current needed to break the emulsion) to promote a relaxed filtrate.

After landing, drilling continues into the pay zone, with an average 8½″ bit for example with teeth made of tungsten carbide. When the wellbore gets 88-90 degrees in angle with respect to the horizontal, the well is considered “landed”. With the addition of 30-50 BBLs of acid (citric; hydrochloric; formic; acetic) for every 950-970 BBLs of circulating drilling mud, the acid is added slowly at the suction pit directly from barrels; 8 BBL totes or possibly larger vessels. Then the fluid parameters are monitored for viscosity, pH; salinity; weight; plastic viscosity; yield point and the 6 RPM reading of the API VG (Variable Gravity) Meter.

The parameters described above have relative importance, but Mud Engineers have additional chemical and physical tests they run, usually twice/day which go into reports with the hydraulics and flow velocities to make sure the hole is cleaning, carrying the cuttings out. The Mud Report lists drilling assembly from top to bottom; casings in place; detailed pump; bit; activity; solids; salt content; oil and water content; mud volumes data, materials used; activity and any comments. At this point, drilling and testing cannot specifically measure how big the fractures have become in the horizontal borehole or estimate the amount of gas, oil, water and condensate that this well will eventually produce. However, pilot testing of current drilled samples that come over the shaker screen and those that are discharged from the other solids control equipment, can be analyzed to help infer that something similar may be happening down hole to the producing zone's shale. Shale dehydration, shrinking and acid etching matrixes are seen if the drilling fluid is kept in its physical and chemical parameters. The questions of production are answered when the “Christmas” Production Tree is opened.

That production is substantially maximized by using a drilling fluid system of the present invention for the horizontal borehole that opens up fractures, instead of swelling them closed. Shale can have problems like an outside “skin” and crevice packing from too much solids contamination. In addition, the shale can actually swell closed if the salt level in the drilling fluid is below the salt level in the shale's water content (Marcellus is about 30,000 ppm Cl−). As salt concentration increases (above the shale's water salt level), free water is removed because of osmotic effects (SPE 89831 says on page 5) Influence of NaCl Solutions on water/Ion movement. High salinity mud inhibits shale swelling and also stabilizes the wellbore. Water moisture in lower salt content shale will be drawn to the higher salt content of the drilling fluid.

The mud system of the present invention includes a straightforward parameter guideline for the horizontal borehole section. The drilling fluid has salt saturated water; approximately 0.5-5% acid; a relaxed filtrate of approximately 12-24 ml/30 minutes; and solids control maintains the low gravity solids at substantially 3% or less. The relaxed filtrate is measured by an API Filter Press. If the half size (half the filtered area) is employed, the results are doubled. A 6 ml/30 minute result is an API 12 ml/30 minutes resulting filtrate.

Primary Parameters while Drilling Horizontal Section
1) Salt Saturated water as measured by Cl− testing; NaCl (table or sea salt) above 250,000 ppm; KCl (Potassium Chloride) above 200,000 ppm; CaCl2 greater than 125 pounds/barrel; NaBr greater than 130 pounds/barrel (this is hazardous and PPE-personal protective equipment is used). Refer to standard charts for the other less used brines.
2) 0.5-5% acid by volume (Citric; Acetic; Formic; Hydrochloric), these ratios are determined by region with simple lab testing of previous drilled samples in the lab.
3) Weight or density range, as measured by ECD (equivalent circulating density) with pump pressure to drill at or near balance. Engineers will take into account surge and swab pressures when determining this somewhat narrow range. This planned figure is somewhat flexible during drilling when the hole “talks to you” with friction; gas levels and other input from the driller; software “Pason Monitors” and even other wells. Other wells being fracked up to two miles away can and have entered wellbores that are being drilled. As with Patterson Rig #254 for Range Resources in 2012. That caused several weeks of delays and millions of dollars.
4) Solids Control of LGS (Low Gravity Solids) as low as possible, 2-3% maximum by volume. Run solids control 24/7, even during trips of the well drilling to change bit or mud motor. They are both designed to last the 150 hours or so of drilling the curve and horizontal, but about 30% of the time one fails.

After completing the 8½″ wellbore to the design TD (total depth) and MD (measured depth), usually, a small “rat hole” of an additional 20′-50′ beyond the well hole is drilled for ease in cementing and getting the casing string to be at a proper finishing height on the surface. Then the hole is circulated clean (no more cuttings coming across the shale shaker screens from the return flow line) and the drill pipe is tripped out of the hole. A wire line logging truck then logs the hole electronically, usually with one run or “pass” to TD (total depth), three tools in triple combination (“triple combo”). These three tools obtain better data from water based muds as compared to oil base. Then, because the hole is pretty much gauged to the 8½″ drill bit, casing can be run without a traditional “wiper run” to clean out fill which can be skipped most of the time with this mud system. So, approximately 5″ or 5.5″ casing is picked up in 40′ long “joints” and screwed together as they are fed into the wellbore. The casing is filled periodically with mud, so it does not float. At TD, a valve is activated at the bottom of the casing, allowing for mud to be circulated, cleaning any fill out of the hole. This surface volume of mud, which is usually 500-1,000 barrels, has been circulating through the solids control equipment, getting cleaner and cleaner. Now when the shale shaker cleans up. If cementing is chosen as a completion option-cementers, like Halliburton, take over and pump the cement down the well bore. The 400-800 BBLs of cement displaces an equal amount of drilling fluid from the hole and any extra is put in 500 BBL surface storage tanks. Drilling mud can now fill the casing, by simply following the final barrel of cement that was pumped (its “tail”).

The well is now ready to complete and the drilling rig can shut in the cased well and rig down and move off (RDMO), putting the remainder of their surface mud into tangent surface storage tanks. A production rig moves in and begins completing the well to production. Using the same clean drilling fluid as completion fluid, the well can be completed traditionally with perforations through the casing. The fractures behind the 1.75″ distance between the outside of the casing and the wall of the wellbore is easily overcome with standard perforation methods.

Another option to running 5″ casing is to run a 5″ slotted liner that allows “gravel packing” of pre-selected sizes of round sand or artificial epoxy coated particles to hold open the fractures to maximize production channels. The proppants are pumped into place with the same clean drilling/completion fluid to prevent closures in the hydrocarbon channels or pathways that have been opened up by this engineered fluid. When gas or oil production is brought on line, and passes though those fissures into the wellbore, they bring a varying level of water moisture with a lower level of Salt or Cl− ions. This is always less than the saturated salt level in the gravel packing completion fluid that has previously dehydrated and opened these fractures for production. So, when the shale is exposed to these varying levels of brine water with less salt, the shale will tend to absorb it through osmosis and rehydrate, swelling the channels closed but now the proppants are in place will hold the formation which is trying to swell closed-open.

The “skin” on shale walls is basically composed of polymer, fine solids, and oil or water—but is minimized with this new fluid system. A 1% addition of hypochlorite or similar chemical breaker may be added, if needed.

For additional dollars savings in this situation, the drilling rig can stay on site another day or so and complete this gravel packing to get the well ready to flow and test within days. Example: Chevron/Texaco at Elk Hills, Calif., in 2004, used a drilling rig, which changed over the drilling fluid system to a Saturated Salt NaBr Completion Fluid after running a slotted liner, “gravel packed” and completed the well using the technique of “reverse circulation”. The fluid was pumped ‘down’ the annulus and came back ‘up’ through the slotted production liner and drill pipe. The proppant sand size particles were packed into the production zone around the liner. Other options for completions include individual or combined methods of open hole packers; composite plugs; oil and water swellable packers; and even sinusoidal wellbore shapes are all best supported by this new drilling fluid system's fracturing performance and now its low friction “slickwater” completion characteristics. The reservoir engineer usually decides which completion method combination will best optimize zonal isolation and hence production. Wells produce a ratio of gas; oil and water, which has to be planned for, as their velocities out of the fissures and wellbore vary, causing friction, which can defeat less expensive proppants—decreasing production.

This fluid is versatile, with bulk liquid (hydrochloric; acetic; formic) acids readily available. Encapsulated citric acids are also commercially available.

Citric acid encapsulated in vegetable oil is commercially available from Balchem Chemical, Slate Hill, New York. When dolomite and limestone samples were exposed to this liquid, the etching process was immediate.

Citric acid encapsulated with PNC is available from Dow Chemical. Acid etching of dolomite and limestone was immediate and abrasive.

Citric Acid encapsulated by polymer is available from Rohm America, including carboxylate polymers and cellulose acetate phthalate.

A drilling fluid system that opens fractures and completes a well.

A salt saturated or near salt saturated drilling fluid with water phase to dehydrate shale formations through osmosis, enlarging a crevice or fracture in hydrocarbon producing formations; and HCL (or other acid) to acid etch matrix shale (and other formations), further enlarging a crevice or fracture in hydrocarbon producing formations, allowing also for a variety of other common fracking chemicals; and allowing “gravel packing” of proppants into the producing zone with a saturated salt fluid with clear (or not clear) acid resistant polymer—to hold open the newly enlarged fracture which would eventually swell and begin to narrow when exposed to the less than saturated salt fluid flow of ground water during production of hydrocarbons.

A Water Based Mud system for drilling horizontal and vertical wells with a clear (or non-clear) acid resistant polymer; including saturated or near saturated sodium chloride salt (above 250000 ppm NaCl, 71 ppb);

a range of 0.5%-5.0% HCl (or acetic; formic or citric acids); biodegradable surfactants;
guar gum;
biocides;
polyacrylamide;
friction reducers;
emulsifiers; and
diesel based VOC and BTEX claiming the above.

A Water Based Mud system for drilling horizontal and vertical wells, with a clear (or non-clear) acid resistant polymer; comprising saturated or near saturated Potassium Chloride Salt (above 200000 ppm KCl, 79 ppb) with any variety of 0.5%-5.0% HCl (or acetic; formic or citric acids); biodegradable surfactants; guar gum; biocides; friction reducers; polyacrylamides; emulsifiers; and diesel based VOC and BTEX.

A Water Based Mud system for drilling horizontal and vertical wells, with a clear (or non-clear) acid resistant polymer; comprising saturated or near saturated Calcium Chloride Salt (at least 125 ppb CaCl2) with any variety of 0.5%-5.0% HCl (or acetic; formic or citric acids); biodegradable surfactants; guar gum; biocides; polyacrylamides; friction reducers; emulsifiers; and diesel based VOC and BTEX.

A Water Based Mud system for drilling horizontal and vertical wells, with a clear (or non-clear) acid resistant polymer; comprising saturated or near saturated Sodium Bromide Salt (at least 130 ppb NaBr) with any variety of 0.5%-5.0% HCl (or acetic; formic or citric acids); biodegradable surfactants; guar gum; biocides; polyacrylamides; friction reducers; emulsifiers; and diesel based VOC and BTEX.

An Oil Base Mud system with a water phase for drilling horizontal and vertical wells, with a clear (or non-clear) acid resistant polymer; that employ saturated or near saturated sodium chloride salt (above 250000 ppm NaCl) with any variety of 0.5%-5.0% HCl (or acetic; formic or citric acids); biodegradable surfactants; guar gum; biocides; polyacrylamides; friction reducers; emulsifiers; and diesel based VOC and BTEX claiming the above.

An Oil Base Mud system with a water phase for drilling horizontal and vertical wells, with a clear (or non-clear) acid resistant polymer; that employ saturated or near saturated Potassium Chloride Salt (above 200000 ppm KCl) with any variety of 0.5%-5.0% HCl (acetic; formic or citric acids); biodegradable surfactants; guar gum; biocides; polyacrylamides; friction reducers; emulsifiers; and diesel based VOC and BTEX.

An Oil Base Mud system with a water phase for drilling horizontal and vertical wells, with a clear (or non-clear) acid resistant polymer; that employ saturated or near saturated Calcium Chloride Salt (at least 125 ppb CaCl2) with any variety of 0.5%-5.0% HCl (acidic; formic; or citric acids); biodegradable surfactants; guar gum; biocides; polyacrylamides; friction reducers; emulsifiers; and diesel based VOC and BTEX claiming the above.

An Oil Based Mud system with a water phase for drilling horizontal and vertical wells, with a clear (or non-clear) acid resistant polymer; that employ saturated or near saturated Sodium Bromide Salt (130 ppb NaBr) with any variety of 0.5%-5.0% HCl (acidic; formic or citric acids); biodegradable surfactants; guar gum; biocides; polyacrylamides; friction reducers; emulsifiers; and diesel based VOC and BTEX.

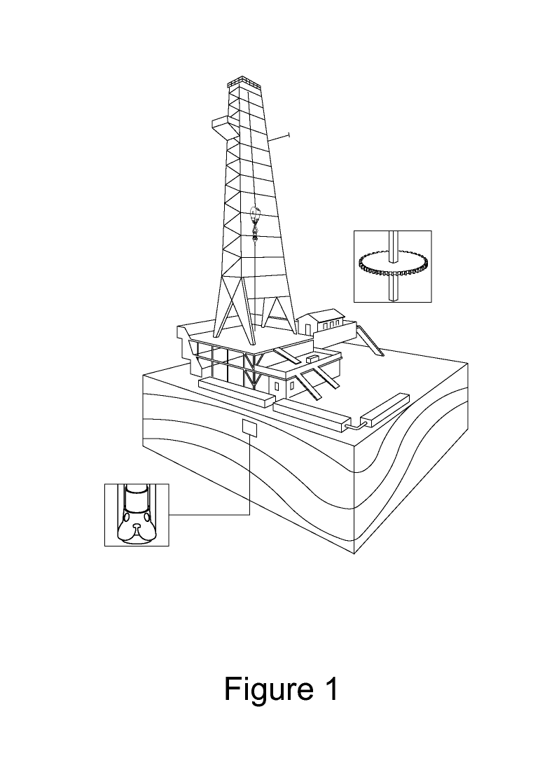

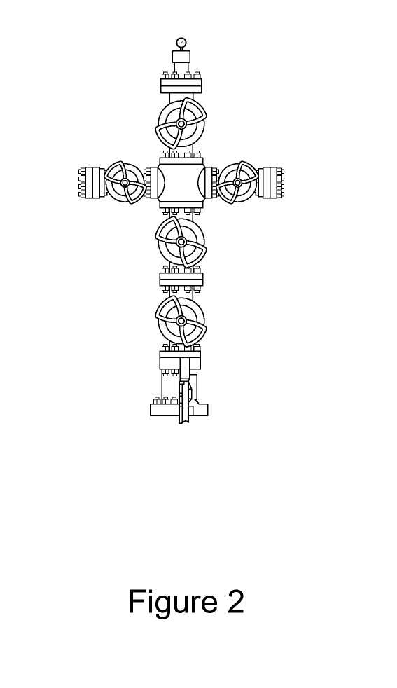

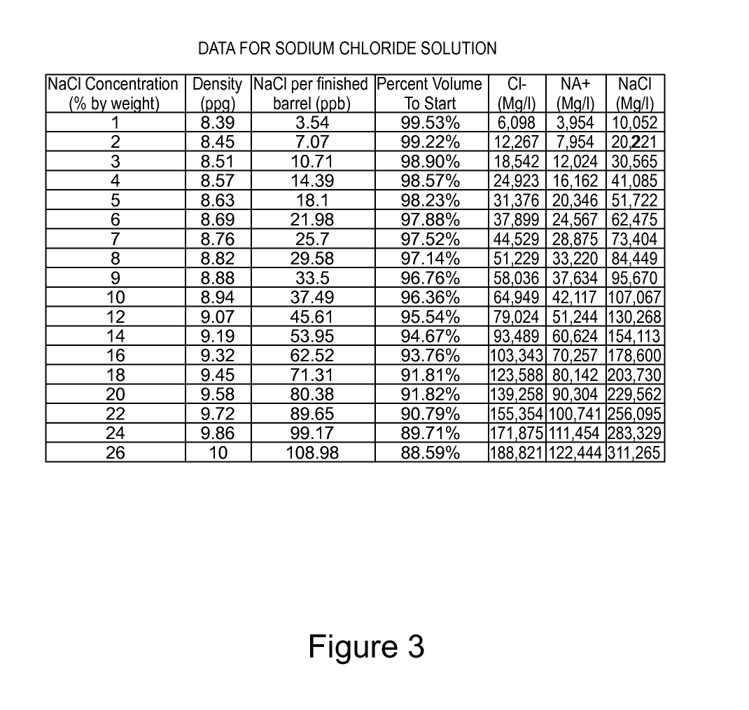

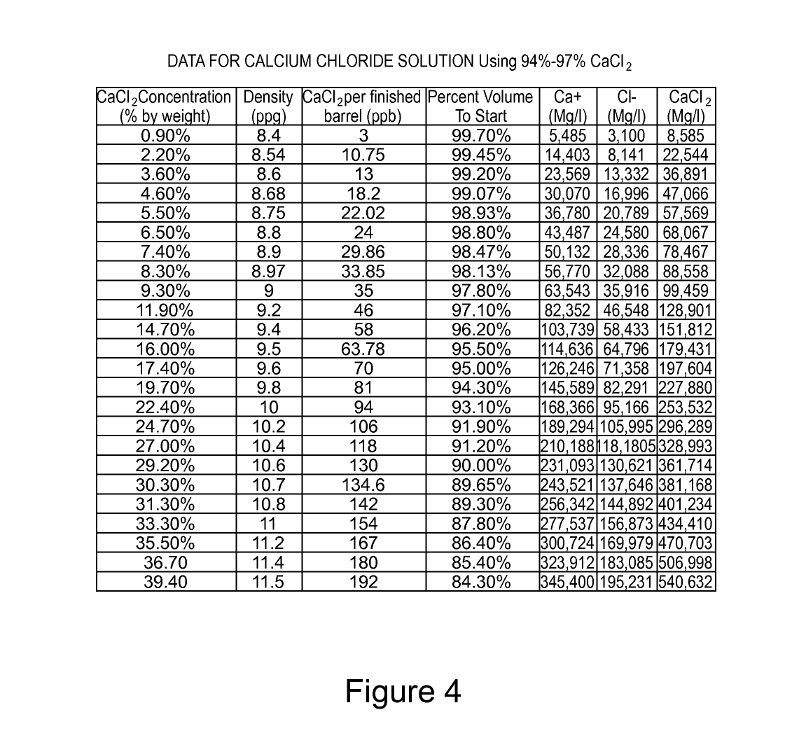

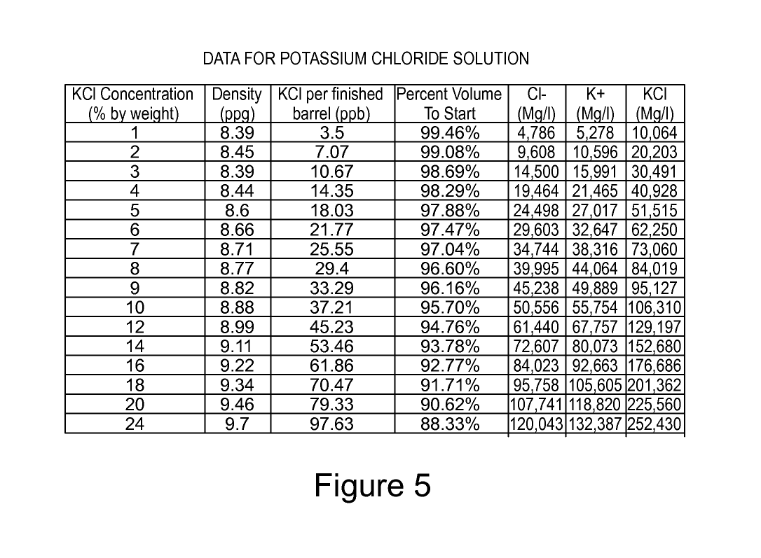

FIG. 1 illustrates an oil well of the present invention; FIG. 2 illustrates a production valve of the present invention; FIGS. 3-5 illustrates data of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A drilling fluid method that opens fractures and completes a well comprising the steps of:
applying a salt saturated or near salt saturated drilling fluid with water phase to dehydrate shale formations through osmosis;
enlarging a crevice or fracture in hydrocarbon producing formations; and
applying HCL to acid etch matrix shale,
enlarging a crevice or fracture in hydrocarbon producing formations, applying “gravel packing” of proppants into the producing zone with a saturated salt fluid with an acid resistant polymer to hold open the newly enlarged fracture which would swell and begin to narrow when exposed to the less than saturated salt fluid flow of ground water during production of hydrocarbons.

2) A Water Based Mud method for drilling horizontal and vertical wells comprising the steps of:
applying an acid resistant polymer including a near saturated sodium chloride salt (above 250000 ppm NaCl, 71 ppb) including HCl in the range of 0.5%-5.0%; a biodegradable surfactant; a guar gum; a biocide; a polyacrylamide; a friction reducer; an emulsifier; and a diesel based VOC and BTEX.

3) A Water Based Mud method for drilling horizontal and vertical wells comprising the steps of:
applying an acid resistant polymer including near saturated Potassium Chloride Salt (above 200000 ppm KCl, 79 ppb) with HCl in the range of 0.5%-5.0%; a biodegradable surfactant; a guar gum; a biocide; a friction reducer; a polyacrylamide; an emulsifier; and a diesel based VOC and BTEX.

4) A Water Based Mud method for drilling horizontal and vertical wells with an acid resistant polymer as in claim 1 comprising the steps of: applying near saturated Calcium Chloride Salt (at least 125 ppb CaCl2) with HCl in the range of 0.5%-5.0%; a biodegradable surfactant; a guar gum; a biocide; a polyacrylamide; a friction reducer; emulsifiers; and a diesel based VOC and BTEX.

5) A Water Based Mud method for drilling horizontal and vertical wells with an acid resistant polymer as in claim 1; comprising the steps of: applying near saturated Sodium Bromide Salt having a concentration of at least 130 ppb NaB with HCl in the range of 0.5%-5.0%; a biodegradable surfactant; a guar gum; a biocide; a polyacrylamide; a friction reducer; an emulsifier; and a diesel based VOC and BTEX.

6) An Oil Base Mud method with a water phase for drilling horizontal and vertical wells with an acid resistant polymer as in claim 1 comprising the steps of: applying near saturated sodium chloride salt having a concentration of exceeding 250000 ppm NaCl) with HCl in the range of 0.5%-5.0%; a biodegradable surfactant; a guar gum; a biocide; a polyacrylamide; a friction reducer; an emulsifier; and a diesel based VOC and BTEX.

7) An Oil Base Mud method with a water phase for drilling horizontal and vertical wells with an acid resistant polymer as in claim 1 comprising the steps of: applying near saturated Potassium Chloride Salt having a concentration above 200000 ppm KCl with HCl in the range of 0.5%-5.0%; a biodegradable surfactant; a guar gum; a biocide; a polyacrylamide; a friction reducer; an emulsifier; and a diesel based VOC and BTEX.

8) An Oil Base Mud method with a water phase for drilling horizontal and vertical wells with an acid resistant polymer as in claim 1, comprising the steps of: applying near saturated Calcium Chloride Salt having a concentration of at least 125 ppb CaCl2 with HCl in the range of 0.5%-5.0%; a biodegradable surfactant; a guar gum; a biocide; a polyacrylamide; a friction reducer; an emulsifier; and a diesel based VOC and BTEX.

9) An Oil Based Mud method with a water phase for drilling horizontal and vertical wells with an acid resistant polymer, comprising the steps of: applying Sodium Bromide Salt having a concentration of approximately 130 ppb NaBr with HCl in the range of 0.5%-5.0% HCl; a biodegradable surfactant; a guar gum; a biocide; a polyacrylamide; a friction reducer; an emulsifier; and a diesel based VOC and BTEX.
